(19) United States
(12) Patent Application Publication
(10) Pub. No.: US 2026/0231034 A1
(43) Pub. Date: Aug. 6, 2026

(54) RECEIVER OPERATION FOR LOW POWER WAKEUP

(71) Applicant: Telefonaktiebolaget LM Ericsson (PUBL), Stockholm (SE)

(72) Inventors: Chunhui Zhang, STOCKHOLM (SE); Olof Liberg, ENSKEDE (SE); Mohammad Mozaffari, FREMONT, CA (US); Ravikiran Nory, SAN JOSE, CA (US); Ajit Nimbalker, Dublin, CA (US); Andreas Höglund, SOLNA (SE); Yanpeng Yang, Järfälla (SE)

(21) Appl. No.: 19/156,487

(22) PCT Filed: Feb. 16, 2024
(86) PCT No.: PCT/IB2024/051506

§ 371 Date: Aug. 14, 2025

Related U.S. Application Data
(60) Provisional application No. 63/485,372, filed on Feb. 16, 2023.

(51) Int. Cl. H04W 52/02; H04W 68/02

(52) U.S. Cl. CPC H04W 52/0235; H04W 68/02

(57) ABSTRACT

According to some embodiments, a method is performed by a wireless device for performing wake-up signal (WUS) monitoring. The wireless device is capable of operating in a plurality of sleep modes. The method comprises: operating according to a first sleep mode of the plurality of sleep modes; determining to switch from the first sleep mode to a second sleep mode of the plurality of sleep modes; and operating according to the second sleep mode.

### TECHNICAL FIELD

Embodiments of the present disclosure are directed to wireless communications and, more particularly, to receiver operation for low power wakeup.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Wireless devices in a wireless communication network may use wake up signals to conserve power. Wake-up receiver (WUR), sometimes also referred to as ‘wake-up radio’, is about enabling a low power receiver in a user equipment (UE) which, for the detection of a wake-up signal (WUS), wakes up the main (baseband/higher power) receiver to detect an incoming message, typically paging (e.g., physical downlink control channel (PDCCH) in paging occasions (PO), scheduling the paging message on physical downlink shared channel (PDSCH)). The main benefit of employing WUR is lowering energy consumption and longer device battery life, or at a fixed energy consumption the downlink latency can be reduced (shorter discontinuous reception (DRX)/duty-cycles and more frequent checks for incoming transmissions).

FIG. 1 illustrates a location of a WUS and the paging occasion to which it is associated. The horizontal axis represents time domain.

Third Generation Partnership Project (3GPP) Release-15 specified WUS for narrowband Internet-of-things (NB-IoT) and Long Term Evolution for machines (LTE-M). The main motivation was UE energy consumption reduction, because with the coverage enhancement PDCCH could be repeated many times and the WUS is relatively much shorter and thus requires less reception time for the UE. The logic is that a UE checks for a WUS a certain time before its PO, and only if a WUS is detected does the UE continue to check for PDCCH in the PO, and if not, which is most of the time, the UE goes back to a sleep state to conserve energy. Due to the coverage enhancements, the WUS can be of variable length depending on the UE's coverage, see FIG. 2.

FIG. 2 illustrates WUS for NB-IoT and LTE-M. The horizontal axis represent time domain.

A WUS is based on the transmission of a short signal that indicates to the UE that the UE should continue to decode the downlink control channel, e.g., full NPDCCH for NB-IoT. If such signal is absent (discontinuous transmission (DTX), i.e., UE does not detect the signal) then the UE can go back to sleep without decoding the downlink control channel. The decoding time for a WUS is considerably shorter than that of the full NPDCCH because it essentially only needs to contain one bit of information, whereas the NPDCCH may contain up to 35 bits of information. This, in turn, reduces UE power consumption and leads to longer UE battery life.

The WUS is transmitted only when there is a paging for the UE. If there is no paging for the UE, then the WUS is not transmitted (i.e., implying a DTX) and the UE goes back to deep sleep, e.g., upon detecting DTX instead of WUS. This is illustrated in FIG. 1 where white blocks indicate possible WUS and PO positions and the black boxes indicate actual WUS and PO positions.

The specification of Rel-15 WUS is spread out over several parts of the LTE 36-series standard, e.g., 36.211, 36.213, 36.304 and 36.331.

A UE reports its WUS capability to the network, and WUS gap capability (see below). Further WUS information was added to the paging message/request from a mobility management entity (MME) to an eNB (see UE radio paging capabilities). An eNB will use WUS for paging the UE if and only if 1) WUS is enabled in the cell (i.e., WUS-Config present in system information (SI)), and 2) the UE supports WUS according to the wake UpSignal-r15 UE capability (see also the description of WUS gap below).

WUS was introduced for both LTE-M and NB-IoT with support for both DRX and eDRX, the former with a 1-to-1 mapping between the WUS and the PO, and for the latter in an addition with the possible configuration of 1-to-N (many) POs. The eNB can configure one WUS gap for UEs using DRX, and another one for UEs using eDRX [TS 36.331, examples are given for NB-IoT, LTE-M is similar]:

### WUS-Config-NB Information Element

| | |
|---|---|
| WUS-Config-NB-r15 ::= | SEQUENCE { |
| maxDurationFactor-r15 | WUS-MaxDurationFactor-NB-r15, |
| numPOs-r15 | ENUMERATED {n1, n2, n4} DEFAULT n1, |
| numDRX-CyclesRelaxed-r15 | ENUMERATED {n1, n2, n4, n8}, |
| timeOffsetDRX-r15 | ENUMERATED {ms40, ms80, ms160, ms240}, |
| timeOffset-eDRX-Short-r15 | ENUMERATED {ms40, ms80, ms160, ms240}, |
| timeOffset-eDRX-Long-r15 | ENUMERATED {ms1000, ms2000} OPTIONAL, -- |

Need OP
...
}

| | |
|---|---|
| WUS-ConfigPerCarrier-NB-r15 ::= | SEQUENCE { |
| maxDurationFactor-r15 | WUS-MaxDurationFactor-NB-r15 |

}

| | |
|---|---|
| WUS-MaxDurationFactor-NB-r15 ::= | ENUMERATED {one128th, one64th, one32th, one16th, |
| | oneEighth, oneQuarter, oneHalf} |

### WUS-Config-NB Field Descriptions

timeOffsetDRX
When DRX is used, non-zero gap from the end of the configured maximum WUS duration to the associated PO, see TS 36.304, clause 7.4 and TS 36.211. In milliseconds. Value ms40 corresponds to 40 ms, value ms80 corresponds to 80 ms and so on.
   timeOffset-eDRX-Short
When eDRX is used, the short non-zero gap from the end of the configured maximum WUS duration to the associated PO, see TS 36.304, clause 7.4 and TS 36.211. In milliseconds. Value ms40 corresponds to 40 ms, value ms80 corresponds to 80 ms and so on.
E-UTRAN configures timeOffset-eDRX-Short to a value longer than or equal to timeOffsetDRX.
   timeOffset-eDRX-Long
When eDRX is used, the long non-zero gap from the end of the configured maximum WUS duration to the associated PO, see TS 36.304, clause 7.4 and TS 36.211. In milliseconds. Value ms1000 corresponds to 1000 ms, value ms2000 corresponds to 2000 ms.

The UE capabilities may also indicate the minimum WUS gaps required for the UE to be able to decode PDCCH in the associated PO, for DRX and eDRX, respectively [TS 36.331]:

### UE-RadioPagingInfo-NB Information Element

| UE-RadioPagingInfo-NB-r13 ::= | SEQUENCE { | |
|---|---|---|
| ue-Category-NB-r13 | ENUMERATED {nb1} | OPTIONAL, |

...,

| | | |
|---|---|---|
| [[ multiCarrierPaging-r14 | ENUMERATED {true} | OPTIONAL |

]],

| | | |
|---|---|---|
| [[ mixedOperationMode-r15 | ENUMERATED {supported} | OPTIONAL, |
| wakeUpSignal-r15 | ENUMERATED {true} | OPTIONAL, |

| | |
|---|---|
| wakeUpSignalMinGap-eDRX-r15 | ENUMERATED {ms40, ms240, ms1000, ms2000} |

OPTIONAL,

| | | |
|---|---|---|
| multiCarrierPagingTDD-r15 | ENUMERATED {true} | OPTIONAL |

]],

| | | |
|---|---|---|
| [[ ue-Category-NB-r16 | ENUMERATED {nb2} | OPTIONAL, |
| groupWakeUpSignal-r16 | ENUMERATED {true} | OPTIONAL, |
| groupWakeUpSignalAlternation-r16 | ENUMERATED {true} | OPTIONAL |

]]
}

The parameter wakeUpSignalMinGap-eDRX indicates the minimum gap the UE supports between WUS or group wake-up signal (GWUS) and the associated PO for eDRX in frequency division duplex (FDD), as specified in TS 36.304. Value ms40 corresponds to 40 ms, value ms240 corresponds to 240 ms and so on. If this field is included, the UE shall also indicate support for WUS or GWUS for paging in DRX.

At the end of Rel-15, a longer WUS gap of 1s or 2s was introduced to enable the use of WUR. That is, starting up the main baseband receiver if a WUR is used for the detection of WUS may take longer time. If this is supported in the cell, eNB includes timeOffset-eDRX-Long in the WUS-Config in SI (see above). In TS 36.304 the UE behavior for monitoring paging with WUS is specified, and Table 7.4-1 indicates which WUS time gap the UE (and eNB) should apply depending on the reported UE capability. The relevant portions are reproduced below.

### 7.4 Paging with Wake Up Signal

Paging with Wake Up Signal is only used in the cell in which the UE most recently entered RRC_IDLE triggered by:
reception of RRCEarlyDataComplete; or
reception of RRCConnectionRelease not including noLastCellUpdate; or
reception of RRCConnectionRelease including noLastCellUpdate and the UE was using (G) WUS in this cell prior to this RRC connection attempt.
   If the UE is in RRC_IDLE, the UE is not using GWUS according to clause 7.5 and the UE supports WUS and WUS configuration is provided in system information, the UE shall monitor WUS using the WUS parameters provided in System Information. When DRX is used and the UE detects WUS the UE shall monitor the following PO. When extended DRX is used and the UE detects WUS the UE shall monitor the following numPOs POs or until a paging message including the UE's NAS identity is received, whichever is earlier. If the UE does not detect WUS the UE is not required to monitor the following PO(s). If the UE missed a WUS occasion (e.g. due to cell reselection), it monitors every PO until the start of next WUS or until the PTW ends, whichever is earlier.
numPOs=Number of consecutive Paging Occasions (PO) mapped to one WUS provided in system information where (numPOs≥1).
   The WUS configuration, provided in system information, includes time-offset between end of WUS and start of the first PO of the numPOs POs UE is required to monitor. The timeoffset in subframes, used to calculate the start of a subframe g0 (see TS 36.213), is defined as follows:
for UE using DRX, it is the signalled timeoffsetDRX;
for UE using eDRX, it is the signalled timeoffset-eDRX-Short if timeoffset-eDRX-Long is not broadcasted;
for UE using eDRX, it is the value determined according to Table 7.4-1 if timeoffset-eDRX-Long is broadcasted

TABLE 7.4-1
Determination of GAP between end of WUS and associated PO

| | | timeoffset-eDRX-Long | |
|---|---|---|---|
| | | 1000 ms | 2000 ms |
| UE Reported | 40 ms | timeoffset- | timeoffset-eDRX- |
| wakeUpSignalMinGap- | or not | eDRX-Short | Short |
| | reported | | |
| | 240 ms | timeoffset- | timeoffset-eDRX- |
| | | eDRX-Short | Short |
| | 1000 ms | timeoffset- | timeoffset-eDRX- |
| | | eDRX-Long | Long |
| | 2000 ms | timeoffset- | timeoffset-eDRX- |
| | | eDRX-Short | Long |

The timeoffset is used to determine the actual subframe g0 as follows (taking into consideration resultant SFN and/or H-SFN wrap-around of this computation):
g0=PO-timeoffset, where PO is the Paging Occasion subframe as defined in clause 7.1
   For UE using eDRX, the same time offset applies between the end of WUS and associated first PO of the nomos POs for all the WUS occurrences for a PTW.
   The timeoffset, g0, is used to calculate the start of the WUS as defined in TS 36.213.

In essence, the UE will only use WUR, or timeOffset-eDRX-Long, if it is capable of starting up the main receiver as quickly as indicated by the value used in SI. If not, it will fall back to using timeOffset-eDRX-Short (without WUR).

FIG. 3 illustrates the use of eDRX and DRX WUS gaps for NB-IoT and LTE-M. The horizontal axis represents time domain.

Because UEs share POs, the eNB may, in the worst case, have to transmit up to three WUSs for one PO, i.e., corresponding to timeoffsetDRX, timeoffset-eDRX-Short, and timeoffset-eDRX-Long.

The Rel-16 WID agreed that WUS should be further developed to also include UE grouping, such that the number of UEs that are triggered by a WUS is further narrowed down to a smaller subset of the UEs that are associated with a specific paging occasion (PO).

The objective is to specify improvements for machine-type communications for bandwidth reduced low complexity (BL)/coverage enhancement (CE) UEs, such as improved downlink transmission efficiency and/or UE power consumption including support for UE-GWUS.

One purpose is to reduce the false paging rate, i.e., avoid that a given UE is unnecessarily woken up by a WUS transmission intended for another UE. This feature is referred to as Rel-16 group WUS, or GWUS. However, this is not directly related to WUR and will not further be explained herein.

Rel-17 discussions started on introducing a WUS for NR, then called ‘Paging Early Indication’ (PEI). However, because at the time no coverage enhancement was specified for NR, the only gain for Rel-17 PEI was for scenarios where the small fraction of UEs are in bad coverage and with large synchronization error due to the use of longer DRX cycles. The gain for such UEs were that with the use of PEI they would typically only have to acquire one SSB before decoding PEI, instead of up to 3 SSBs if PEI is not used. For must UEs, Rel-17 PEI will result in gains or increased performance.

Rel-17 PEI will also support UE grouping for false paging reduction, similar to the Rel-16 GWUS above, which will have some gains at higher paging load.

PEI will be PDCCH-based, as described below, making it less interesting for WUR (i.e., the main baseband receiver is required for decoding PEI).

In Rel-18, there has been rather large interest to introduce WUR for New Radio (NR). As explained above, the only specification support needed to be able to use a WUR in the UE is the specification of a WUS and a long enough time gap between the WUS and the PDCCH in the PO (to enable the UE to start up the main receiver). Therefore, the main difference to Rel-17 PEI is the WUS in Rel-18 should not be PDCCH-based and allow for a simpler and low power receiver, i.e., WUR with simple modulation and detection techniques (e.g., using on-off keying, (OOK) modulation and non-coherent detection).

In Rel-18, a study item on “low-power wake-up signal and receiver for NR” was approved. The relevant justification and objective include the following (RP-213645).

Fifth generation (5G) systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in Radio Resource Control (RRC) idle/inactive state and hundreds of milliwatts in RRC connected state. Designs to prolong battery life is a necessity for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years as described in TR 38.875. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle. To meet the battery life requirements above, eDRX cycle with large value is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long eDRX cycle cannot meet the delay requirements. Thus, eDRX is apparently not suitable for latency-critical use cases. The intention is to study ultra-low power mechanism that can support low latency in Rel-18, e.g., lower than eDRX latency.

Currently, UEs need to periodically wake up once per DRX cycle, which dominates the power consumption in periods with no signalling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on.

The power consumption for monitoring wake-up signal depends on the wake-up signal design and the hardware module of the wake-up receiver used for signal detecting and processing.

The study should primarily target low-power WUS/WUR for power-sensitive, small form-factor devices including IoT use cases (such as industrial sensors, controllers) and wearables. Other use cases are not precluded, e.g., XR/smart glasses, smart phones.

As opposed to the work on UE power savings in previous releases, the study will not require existing signals to be used as WUS. All WUS solutions identified shall be able to operate in a cell supporting legacy UEs. Solutions should target substantial gains compared to the existing Rel-15/16/17 UE power saving mechanisms. Other aspects such as detection performance, coverage, UE complexity, should be covered by the evaluation.

The study item includes the following objectives:
Identify evaluation methodology (including the use cases) and key performance indicators (KPIs). Primarily target low-power WUS/WUR for power-sensitive, small form-factor devices including IoT use cases (such as industrial sensors, controllers) and wearables
Study and evaluate low-power wake-up receiver architectures
Study and evaluate wake-up signal designs to support wake-up receivers
Study and evaluate layer one (L1) procedures and higher layer protocol changes needed to support the wake-up signals
Study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead should be included in the study

For more details on, e.g., suggestions on WUR architecture and design, receiver power vs. sensitivity trade-off see e.g. RP-212005, RP-212254, RP-212367, and RP-212427.

A benefit of WUR is to reduce the energy consumption of the receiver, such that unless there is any paging and data for the UE the UE can remain in a power saving state. This will extend the battery life of the device, or alternatively enable shorter downlink latency (shorter DRX) at a fixed battery life. For short-range communication, the WUR power can be low enough (~3 uW) that this can even, in combination with energy harvesting, enable that the WUR is continuously on (i.e., DRX or duty-cycling is not used) without the need for a battery. This can be considered as a key enabler of battery-less devices towards sixth generation (6G).

In Institute of Electrical and Electronics Engineers (IEEE), the support for WUR has been specified to a greater extent than in 3GPP. That is, the focus was on low power WUR from the start and the design uses WUR not only for receiving the WUS but also other control signals and signaling, such as synchronization and mobility information. This enables the stations (corresponding to UEs in 3GPP) to only use the WUR when there is no user-plane data transmission ongoing.

Similar to the 3GPP solution, the use of WUR is only enabled in stations and not in access points (APs), that is for downlink communication only. The AP advertises that it has WUR operation capability, along with WUR configuration parameters (among other info, in which band/channel WUR is operational, which can be different from the band/channel used for data transmission using the main receiver, e.g. WUR in 2.4 GHz band but data communication in 5 GHz band. Also note that the WUR operating channel is advertised in the beacon, and that the WUR discovery operating channel may be different from the WUR operating channel). Stations can then request to be configured with WUR mode of operation. This request has to be granted by the AP, and if it is granted, the station is further configured/setup for WUR mode of operation (the configuration is only valid for the connection to the associated AP, and further the configuration must be torn down/de-configured if WUR is not to be used anymore). Both continuous WUR (receiver open all the time) and duty-cycled WUR (receiver only open during preconfigured time slots) mode of operations are supported. For the latter, the length of the duty-cycles and on-time during wake up is part of the WUR configuration.

Unlike the 3GPP solution, the WUR operation mode is a sub-state of the regular operation, and upon the detection of a WUS transmission from the AP, the station will resume the power saving mechanism it was configured with before entering the WUR operation mode. That is, IEEE has specified a number of different power saving mechanisms, and for example if duty-cycled monitoring of the downlink has been configured for the station it will switch to that upon detection of the WUS (i.e., unlike the specified 3GPP mechanism which only covers paging, and the UE will continue to monitor PDCCH if WUS is detected). In this way the IEEE WUR functionality is more general, and still allows for the station to, upon detection of WUS, monitor paging by checking in the beacon from the AP for which stations there is data, or for the station to directly respond with an uplink transmission.

A station receiving the IEEE WUS must synchronize to the wireless medium prior to performing any transmissions, i.e., using synchronization information in the beacon from the AP (typically transmitted every 100 ms) or from the transmission to another station. Synchronization to the wireless medium refers to the following in IEEE 802.11; a station changing from sleep to awake to transmit must perform channel clear assessment until it receives one or more frames that allow it to correctly set the virtual carrier sensing. This is to prevent collisions with transmissions from hidden nodes. Essentially the virtual carrier sensing tells a station to defer for a time period even if the wireless medium appears to be idle, and can be set by receiving frames that indicate the duration of an ongoing frame exchange. In WiFi typically one beacon transmission is enough to synchronization for the station (i.e., no need to acquire several transmission due to poor coverage). Unlike operation in licensed bands, the station also has to apply carrier sensing, and also possibly reacquire channel sensing parameters, before uplink transmission.

The physical WUS in IEEE contains complete frames that must be processed by the station. The drawback with this design is that it requires more processing and handling and processing in the station, i.e., compared to a simple WUR design that triggers one pre-defined activity when WUS is detected. A benefit is that it contains more information and the solution is more general. The IEEE WUS contains information to indicate if the WUS is a WUR synchronization beacon (see below), a WUR discovery beacon (see below), or a regular WUS (intended to wake the station up). The WUS can also contain proprietary frames, which could, e.g., be used to directly turn actuators on/off. The transmission uses on/off keying (OOK) modulation, using Manchester coding, but is using multi-carrier OOK which can be generated by an orthogonal frequency division multiplexing (OFDM) transmitter (i.e., WUR can be enabled as a software upgrade in APs). The WUS is 4 MHz wide, but a whole 20 MHz channel is reserved. The WUS starts with a 20 MHz legacy preamble (to allow other stations to perform carrier sense) followed by 4 MHz Manchester coded OOK. Two data rates are supported: 62.5 kbps and 250 kbps, and link adaptation is up to the AP (each packet is self-contained and includes the data rate, i.e., in the WUR there are two possible synchronization words used to signal the data rate).

The WUS can contain the following information: station ID, or group ID (grouping of stations is supported); payload up to 22 bytes; short frames contain only basic info; which WUR frame type plus addressing; ordinary frames contain control info, and in addition proprietary info; WUR beacons contain basic service set identifier (BSS-ID), synchronization information, time counter; similar structure for WUS and WUR beacons (synchronization words indicate the data rate, the station can then detect the header, from this the station can tell if it is WUS or beacon, then check body); and WUR discovery frames contain mobility related information to allow for lower power scan (see below).

Regarding mobility, both WUR synchronization beacons and WUR discovery beacons have been specified, which only requires the WUR to be used for reception, such that stations can stay in the WUR operation mode unless there is data transmission for the station. In other words, stations only need to switch back to legacy power save mode (PSM) upon WUS detection (or when moving to a new AP). WUR synchronization beacons are used by stations to obtain rough synchronization (for data transmission the legacy beacon must still be acquired), and WUR discovery beacons are used to carry (legacy) mobility information to enable quick/low energy scanning (allowing stations, only using the WUR, to get information related to local and roaming scans for nearby APs, e.g., service set identifier (SSID) and main radio (MR) operating channels, if the channel quality should deteriorate).

That is, in the WUR discovery beacon the AP can indicate one or more BSS (basic service set, and the BSS-ID has a one-to-one mapping with the assigned SSID name) in which WUR is supported such that stations do not have to scan all frequencies/channels. Because the WUR discovery beacon contains the legacy mobility information, it means there is some duplication/redundancy in the broadcasted information. This allows for low power scanning, using only the WUR. Note however that mobility in IEEE is restricted to the same AP, and that hand-over between APs etc. is not supported in the same way as in 3GPP. If a station in WUR operation mode moves to a new AP, it would have to move out of WUR operation mode and use the main receiver to obtain the beacon, sync, configuration, and associate to the new AP.

There currently exist certain challenges. For example, a main benefit of Rel-18 NR WUR comes from enabling the main receiver to stay in a power saving state as much as possible. The longer the main receiver can stay in such a sleep state, the bigger the gain. In addition, a deeper sleep state, i.e., the “ultra-deep sleep (UDS)” has been considered. In UDS state, more functionality and hardware can be shut down, which will further increase the WUR gain, however, at the expense of a longer start up time and much higher transition energy compared with regular deep sleep.

In current discussions, the main radio of the UE is assumed to always UDS for energy saving in RRC idle mode when operating with WUR. However, UDS may not be the best option in certain conditions, e.g., when UE wake up rate (paging and/or false alarm rate (FAR)) is high. The UE needs to wake up more often in such cases, and the high transition energy will cancel the potential energy saving gains. This may also apply for connected mode operations. Therefore, a mechanism is needed on the UE side to ensure suitable sleep state to maximize the energy saving.

### SUMMARY

As described above, certain challenges currently exist with wake-up signal (WUS) and New Radio (NR). From the gNB perspective, an offset is needed between WUS and paging occasion (PO) to guarantee the user equipment (UE) can wake up before the PO. When the main radio executes ultra-deep sleep (UDS), the offset should be long enough to cover the ramp-up and resynchronization period. However, if the discontinuous reception (DRX) cycle length is shorter than the UDS ramp-up and resynchronization time, the corresponding offset needs to be adjusted as well.

Certain aspects of the present disclosure and their embodiments may provide solutions to these or other challenges. In particular embodiments, depending on various criteria, a gNB may configure different offsets after WUS detection based on, e.g., pre-defined tables. A UE may switch sleep modes given different conditions or certain offsets after WUS detection configured by gNB.

According to some embodiments, a method is performed by a wireless device for performing WUS monitoring. The wireless device is capable of operating in a plurality of sleep modes. The method comprises: operating according to a first sleep mode of the plurality of sleep modes; determining to switch from the first sleep mode to a second sleep mode of the plurality of sleep modes; and operating according to the second sleep mode.

In particular embodiments, determining to switch from the first sleep mode to the second sleep mode is based on a time offset between a WUS and a PO.

In particular embodiments, determining to switch from the first sleep mode to the second sleep mode is based on one or more of a: latency requirement; quality of service (QoS); discontinuous reception (DRX) or wakeup radio (WUR) duty-cycle length; Radio Resource Control (RRC) state; paging rate; traffic characteristics; WUR false alarm rate; coverage condition and deployment scenario; time-frequency synchronization requirements; Radio Resource Management (RRM) measurements; receiver architecture; clock parameters; and battery level.

In particular embodiments, determining to switch from the first sleep mode to the second sleep mode is based on a WUS detection rate for the wireless device or a wake-up probability for the wireless device. In particular embodiments, determining to switch from the first sleep mode to the second sleep mode is based on a timer associated with the first sleep mode.

In particular embodiments, determining to switch from the first sleep mode to the second sleep mode comprises the wireless device autonomously determining to switch from the first sleep mode to the second sleep mode. In particular embodiments, determining to switch from the first sleep mode to the second sleep mode comprises receiving an indication from a network node to switch from the first sleep mode to the second sleep mode.

In particular embodiments, the method further comprises transmitting to a network node an indication of capabilities of the wireless device associated with the plurality of sleep modes.

In particular embodiments, the method further comprises receiving an indication of an offset time between a WUS and a PO.

In particular embodiments, the method further comprises receiving an indication of a wake-up probability group associated with the wireless device.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a network node in communication with a wireless device configured for performing wakeup signal monitoring. The wireless device is capable of operating in a plurality of sleep modes. The method comprises determining one or more timing offsets for a wireless device. The one or more timing offsets apply to a time offset after the wireless device detects a WUS. The method further comprises transmitting the one or more timing offsets to the wireless device.

In particular embodiments, determining one or more timing offsets is based on a sleep mode of the wireless device. Determining one or more timing offsets may be further based on one or more of a wakeup probability group and a DRX cycle associated with the wireless device.

In particular embodiments, a timing offset of the one or more timing offsets comprises an offset between the WUS and a PO.

In particular embodiments, the method further comprises transmitting an indication to the wireless device to switch from a first sleep mode to a second sleep mode.

In particular embodiments, the method further comprises receiving from the wireless device an indication of capabilities of the wireless device associated with the plurality of sleep modes.

In particular embodiments, the method further comprises transmitting to the wireless device an indication of wake-up probability group associated with the wireless device.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a location of a wake-up signal (WUS) and the paging occasion to which it is associated;

FIG. 2 illustrates WUS for narrowband Internet-of-things (NB-IoT) and Long Term Evolution for machines (LTE-M);

FIG. 3 illustrates the use of eDRX and DRX WUS gaps for NB-IoT and LTE-M;

FIG. 4 is a graph illustrating different UE sleep states each with specific power consumption and transition energy/time for switching to ON state;

FIG. 5 illustrates WUS signal offset to main radio drx-on start frame;

FIG. 6 illustrates an example of minimum time offset;

FIG. 7 illustrates another example of minimum time offset;

FIG. 8 illustrates an example communication system, according to certain embodiments;

FIG. 9 illustrates an example user equipment (UE), according to certain embodiments;

FIG. 10 illustrates an example network node, according to certain embodiments;

FIG. 11 illustrates a block diagram of a host, according to certain embodiments;

FIG. 12 illustrates a virtualization environment in which functions implemented by some embodiments may be virtualized, according to certain embodiments;

FIG. 13 illustrates a host communicating via a network node with a UE over a partially wireless connection, according to certain embodiments;

FIG. 14 illustrates a method performed by a wireless device, according to certain embodiments; and

FIG. 15 illustrates a method performed by a source network node, according to certain embodiments.

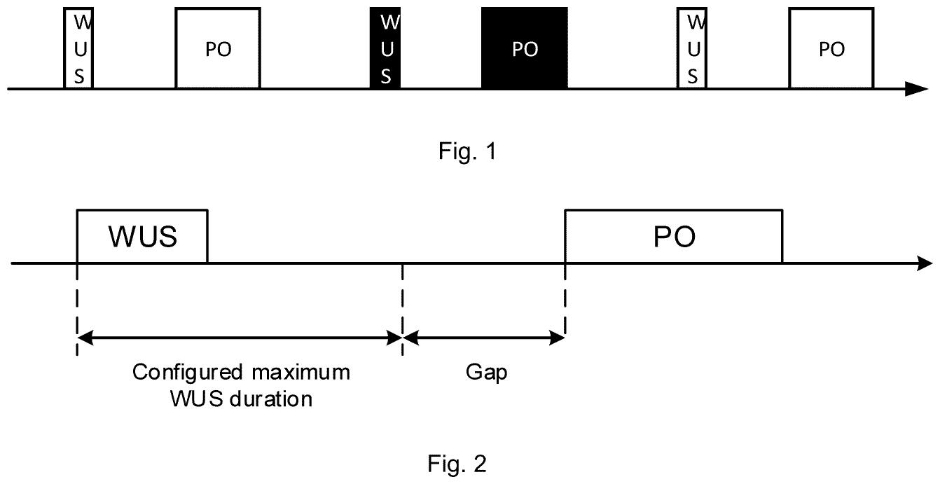

### DETAILED DESCRIPTION

As described above, certain challenges currently exist with wake-up signal (WUS) and New Radio (NR). Certain aspects of the present disclosure and their embodiments may provide solutions to these or other challenges. In particular embodiments, depending on various criteria, a gNB may configure different offsets after WUS detection based on, e.g., pre-defined tables. A user equipment (UE) may switch sleep modes given different conditions or certain offsets after WUS detection configured by gNB.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Particular embodiments are described with respect to a scenario where a UE may go to different sleeping states for the purpose of power saving. Particular embodiments include solutions for efficient UE and network node behavior for maximizing the power saving gain for UEs by properly adopting sleep states and configurations.

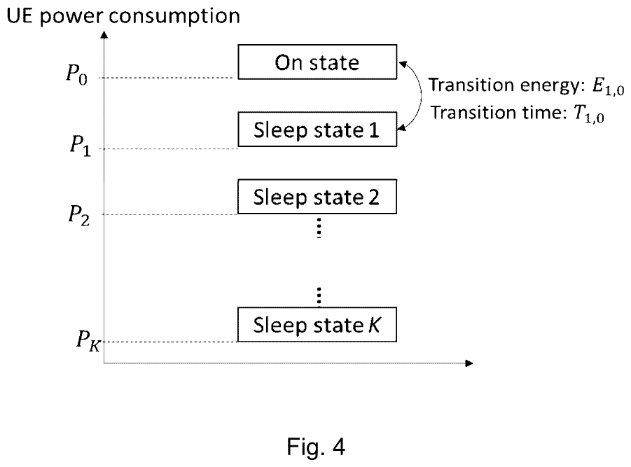

Particular embodiments include UE configuration. Some examples assume the main radio (MR) may operate in K sleep modes, of which the power consumption, transition energy and transition time are different, as illustrated in FIG. 4.

FIG. 4 is a graph illustrating different UE sleep states each with specific power consumption and transition energy/time for switching to ON state (i.e., non-sleep). The vertical axis represents UE power consumption.

Sleep mode K consumes the lowest power while it requires the longest transition time and highest energy to wake up. A lighter sleep mode consumes more power but requires shorter transition time and lower energy to wake up. Specifically, in state i, power is Pᵢ, and transition energy and transition time to state 0 (e.g., non-sleep state) are E_{i,o} and T_{i,o}, respectively. In general, the transition may occur between any two states i and j. Therefore, in particular embodiments the sleep modes of the MR are configurable to make the operation more energy efficient for different use cases.

In one embodiment, for a UE performing WUS monitoring, the MR selects a sleep mode and switches between different sleep modes to maximize its power saving based on various criteria including: offset between WUS and paging occasion (PO); latency requirements and quality of service (QoS); UE discontinuous reception (DRX) or WUR duty-cycle length; Radio Resource Control (RRC) state (Idle, Inactive, Connected); UE paging rate (Idle mode); traffic characteristics (Connected mode); WUR false alarm rate; coverage condition and deployment scenario; time-frequency synchronization requirements; Radio Resource Management (RRM measurements, and RRM measurement relaxations; receiver architecture, clock parameters, there can be mappings between sleep states and receiver architectures; and/or UE battery level.

In one related example, when the UE is in RRC idle mode and the MR operates in sleep mode i between POs, the MR can switch among the K sleeping modes based on the following criteria. When the wake-up rate, defined as WUS detection rate, either correctly or falsely, by the UE per time unit, of the UE is below a certain threshold, the MR can switch to sleep mode i+m (<K). When the wake-up rate is above a certain threshold, the MR can switch to sleep mode i−n (>0). The UE wake-up rate includes correct paging, false paging and false alarm.

As another example, when the latency requirement of the UE is above a certain threshold, the MR can switch to sleep mode i+m (<K). When the latency requirement is below a certain threshold, the MR can switch to sleep mode i−n (>0).

In one alternative formulation of the above, a wake-up probability is used instead. The wake-up probability is defined as the probability that in one of the UE WUS monitoring occasions the UE will receive WUS and need to start the main receiver. In the same way as above, the wake-up probability threshold may be defined per power sleeping state and the UE would only be allowed to enter a deeper sleep state if the wake-up probability is lower than the wake-up probability configured for the sleep state.

| Power sleep state: | Wake-up probability threshold: |
|---|---|
| P₀ | — |
| P₁ | P_{wu1} |
| P₂ | P_{wu2} |
| : | : |
| P_{K} | P_{wuK} |

The wake-up probability depends on the UE's downlink traffic characteristics and WUS duty-cycle length, but also on false alarm rate, WUS UE group size and false paging, etc. Therefore, different wake-up probability thresholds may need to be provided to the UE based on the UE's configuration of WUS duty-cycle length, WUS UE group size, etc. The traffic characteristics do not have an impact because that is in practice what is used to compare to the threshold.

There are various levels of network control for the implementation of the above. One is UE internal, where the UE measures the wake-up probability over time and based on internal thresholds the UE determines the most favorable sleep state to reside in. Models for which power saving state is optimal is up to UE vendors and UE implementation. This option has no specification impact and does not require network control.

Another is full network control, where the network estimates the UE's wake-up probability based on history of data transmissions for the UE that triggered WUS, and WUS transmitted to other UEs in the UE's paging group. Models for which power saving state is up to the network, and the network uses the thresholds internally to determine the most suitable power sleep state for the UE, which is then communicated to the UE. The specification needs to include signaling of power state recommendation to UE (and potentially associated WUS-PO time offset, see below).

In a hybrid solution, power states are specified (e.g., based on the power range of the state). Models for which power saving state is up to the network, and based on the UE's configuration parameters, WUS duty-cycle etc., the network determines the power state thresholds. The UE measure the wake-up probability over time and based on the thresholds communicated to the UE by the network, the UE determines the most favorable sleep state to reside in. The specification needs to include signaling of power state thresholds to UE (and potentially associated WUS-PO time offset, see below).

The embodiments above depend on whether a UE identifier can be included in the WUS payload (pending WUS signal design). This is because if the UE identifier is not included, the WUS will trigger the UE to monitor the legacy paging procedure, no matter if due to a correct WUS, false-alarm, or WUS intended for another UE, and the UE must start up the main receiver (and pay the penalty of the high transition energy). If the WUS does include a UE identifier, there will be no false paging, and the UE will directly trigger random access, and therefore only start up the main receiver when WUS is received containing the UE's own identifier. This would therefore impact how the thresholds are set.

In another related example, when the UE is in RRC connected mode and the MR operates on sleep mode i between On-Durations, the UE can switch among the K sleeping modes based on the following criteria. When the traffic arrival rate of the UE is below a certain threshold, the MR can switch to sleep mode i+m (<K). When the traffic arrival rate is above a certain threshold, the MR can switch to sleep model i−n (>0).

As another example, when the latency requirement of the UE is above a certain threshold, the MR can switch to sleep mode i+m (<K). When the latency requirement is below a certain threshold, the MR can switch to sleep model i−n (>0).

In another embodiment, each sleep state is associated with a timer and the UE remains in a sleep state for a certain duration. For example, UE remains in state i for tᵢ seconds and parameter tᵢ is also optimized, configured, or predetermined based on different criteria. This provides additional flexibility for controlling latency and synchronization error. For example, being in an ultra-deep sleep state for a long time with no or very poor clock accuracy results in significant time-frequency drift, which will require long time for resynchronization when the UE needs to wake up. Therefore, having a timer for controlling sleep states for adjusting the duration of each state is beneficial.

In another embodiment, each sleep state is associated with certain functionalities and specific receiver parameters. Also, depending on the state, some of the receiver components (e.g., clock, memory, low noise amplifier (LNA), analog digital converter (ADC), etc.) may be active or inactive. In this case, there may be mappings between sleep states and receiver functionalities and parameters/architecture/components. The states may be pre-defined based on various aspects, including required power saving and latency requirements, and they are then mapped to various receiver functionalities/parameters/architecture/components.

In another embodiment, UE sleep state selection and/or switching is done periodically or dynamically (e.g., in an event triggered manner). For example, from state i, the UE periodically wakes up every Yᵢ seconds to perform certain tasks.

Some embodiments include gNB configuration. Assuming a gNB can configure N different offsets between WUS and PO. Specifically, offset N takes the longest time. Therefore, different offsets are configurable, which make the operation more flexible and delay tolerant for different use cases.

The time offset between WUS and PO needs to be longer than the start-up time for the main receiver. Therefore, the WUS-PO time offset limits the power sleep states that can be applied by the UE. In this way, the configuration of the WUS-PO time offset indirectly determines the UEs power sleep state (assuming the UE will go to as deep sleep state as it can to minimize the energy consumption). A problem is that for paging of monitoring in Idle and Inactive state, a common configuration is applied for UEs. It is therefore not straight forward to apply a UE-specific WUS-PO time offset, which may be beneficial for UE energy consumption.

For example, different power sleep states may be optimal for two UEs even though they have the same WUS duty/DRX-cycle length, depending on difference in wake-up probability (i.e., if a first UE is almost never paged it would be beneficial to stay in a very deep sleep state, compared to a second UE which is paged in every WUS/paging occasion). Therefore, it is beneficial to be able to configure the UEs with different power sleep states and/or WUS-PO time offset. Keeping track of the UEs wake-up probability requires keeping track of the UEs data profile and/or historical data, which is easiest done on the core network (CN) level.

In one embodiment, the UE is by CN (access and mobility management function (AMF)) configured/assigned with a certain wake-up probability group via non-access stratum (NAS) signaling (or optionally informed by the network which wake-up probability group it belongs to). The CN also upon paging informs the radio access network (RAN) about the UE's wake-up probability group, e.g., as new information element (IE) in the UE radio paging capabilities (for CN paging in Idle), or inform the anchor gNB about the UE's wake-up probability group, e.g., as an addition to the UE context (for RAN paging in Inactive). Upon paging, both the UE and the network will then have a common understanding of both the UE's WUS duty/DRX-cycle in the cell and the UE's wake-up probability. Based on this information, a specified relation, e.g. an equation or table, may be specified by which both the UE and gNB determines the WUS-PO time offset to apply for paging for the UE based on the combination of WUS duty/DRX-cycle and the wake-up probability.

WUS-PO time offset=f(WUS duty/DRX-cycle, wake-up probability). The use of a table in specification is illustrated below, where g₀<g₁<g₂<g₃:

| | | |
|---|---|---|
| | | WUS-PO time |
| DRX cycle: | Wake-up probability: | offset: |

| | | | |
|---|---|---|---|
| 256 | ms | [0, 0.2) | g₁ |
| | | [0.2, 0.6) | g₀ |
| | | [0.6, 1] | g₀ |
| 1280 | ms | [0, 0.2) | g₂ |
| | | [0.2, 0.6) | g₁ |
| | | [0.6, 0.1] | g₀ |
| 10240 | ms | [0, 0.2) | g₃ |
| | | [0.2, 0.6) | g₂ |
| | | [0.6, 1] | g₂ |

Some Embodiments are associated with UE capability. A UE main receiver consists of several building blocks and these building blocks may be selectively put into “sleep” mode depending on how often the main receiver is awaken, which corresponds to different sleep mode in some of the previous embodiments. For example, for a deepest sleep, all the receiver building blocks may be put into “sleep” mode, while if the main receiver wakes up more often, the best choice is to only put parts of the receiver into sleep mode.

TABLE 1
Time to wake up the different building blocks

| Receiver building block | Time to wake up |
|---|---|
| Phase lock loop (PLL) chain | hundreds of us |
| Analog to digital converter (ADC) | tens of us |
| Automatic Gain Control (AGC) | tens of us |
| Digital front-end | tens of us |
| Baseband processing | hundreds of us |

As one example, the wake up time illustrated in Table 1 may be mapped to UE capability corresponding to different sleep mode depending on which building block is to be awakened, e.g., for the deep sleep mode the wake-up time may be several slots and for a shallow sleep mode, the wake-up time may be less than hundreds microseconds.

As another example, the WUR is configured with the same DRX cycle with main receiver, after receiving the WUS signal, the offset between WUS and main receiver drx_ON time is configurable with different offset value depending on different sleep mode. For example, for the long DRx cycle, the MR may go into deep sleep and in such case, the WUS offset to main receiver drx-ON time may be longer, this also means the WUR drx_ON timer will be started earlier to prepare to receive an earlier WUS signal from the network.

As another example, when short-Drx cycles are configured, the WUS offset to main receiver drx_ON timer may be configured with a short time. The shorter offset may benefit the power consumption saving when WUR and MR are sharing the building blocks. This is helpful when shortDRX cycle (e.g., 2 ms, 3 ms) is small while the ramp-up time for waking up the main receiver is large (e.g., in number of slots time frame). To have a constant WUS offset to MR drx-ON may simply mean the main receiver cannot be enabled with DRX mode.

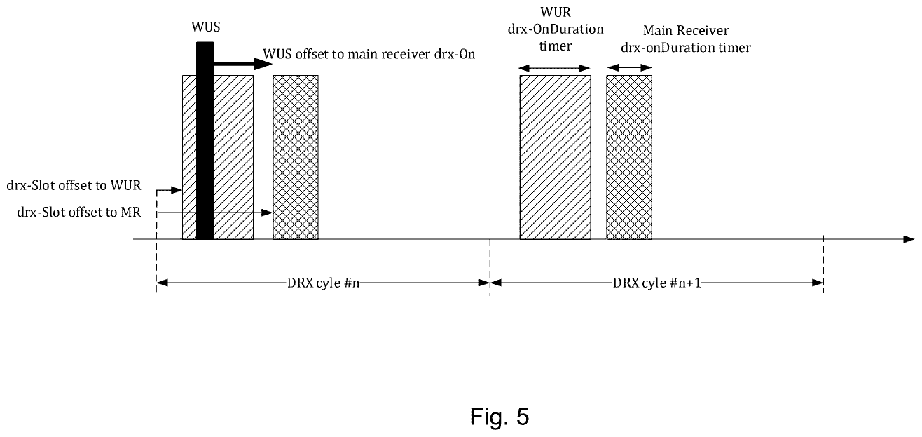

FIG. 5 illustrates WUS signal offset to MR drx-on start frame. The horizontal axis represents time domain.

In RRC Connected state, the connected mode DRX (cDRX) onDurationTimer determines the time the device is expected to monitor the downlink control channel (PDCCH). When the UE receives PDCCH, the drx-InactivityTimer is triggered and the UE monitors the PDCCH until its expiry, which may extend beyond the end of the onDurationTimer.

The end of the onDurationTimer or drx-InactivityTimer and the start of the next onDurationTimer period defines the time a UE is able to enter a power efficient sleep mode, and the time a UE may spend in the same sleep mode.

In one embodiment, the UE capability signaling indicates to the network the maximum time allowances it requires to power down its main receiver to one of one or more power efficient sleep states.

The network may use the capability for configuring the cDRX parameters including the cDRX periodicity, onDurationTimer and drx-InactivityTimer to ensure that the UE has sufficient time to power down and spend time in a power efficient state.

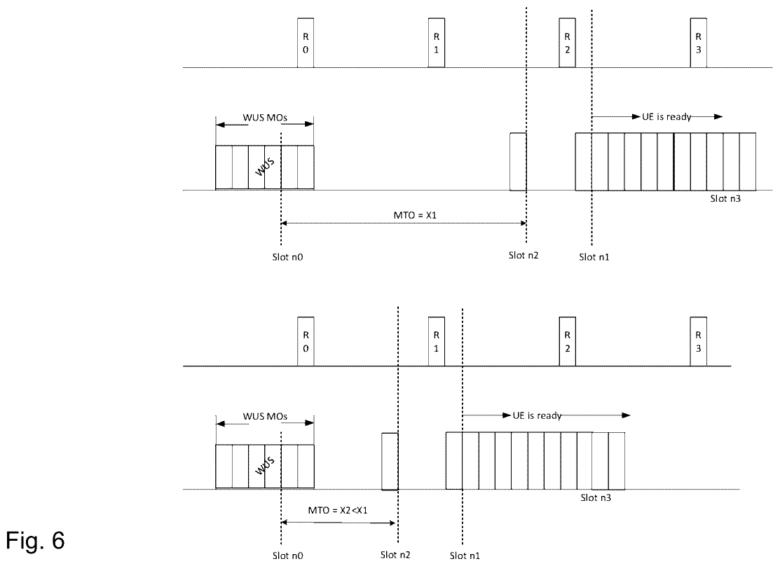

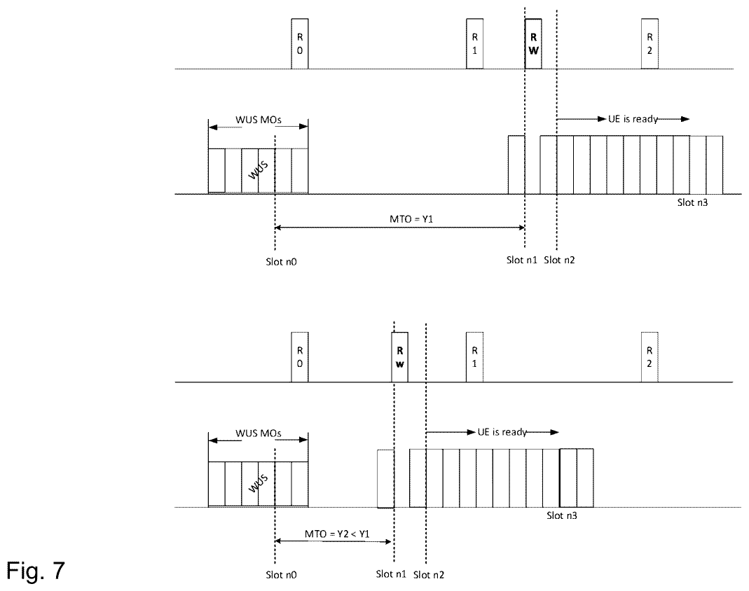

Some embodiments include configuration of a minimum time offset (MTO). An example is illustrated in FIG. 6.

FIG. 6 illustrates an example of minimum time offset. The horizontal axis represents time domain.

In an embodiment, the UE is configured (e.g., via RRC) with a minimum time offset (MTO) associated with wake-up signal (WUS) reception. Upon detection of WUS, the UE determines a first slot (slot n1) such that the UE is ready to perform action(s) related to WUS detection in a set of slots that follow the first slot (or alternately in a set of slots starting with the first slot). The first slot is determined based on a slot in which WUS is detected (slot n0) and the configured MTO. The first slot may also be determined based on availability of one or more reference signals (RSs) for reception by the UE. For example, the first slot may be such that it occurs after the MTO (e.g., after a second slot, slot n2, which is offset by MTO from slot n0) and after additional slot(s) with the one or more reference signals. In response to WUS detection, the UE performs the WUS related action(s) in a third slot (slot n3) from the set of slots. Slot n3 need not be same as slot n1 or a slot that immediately follows slot n1.

The one or more reference signals (RSS) can include one or multiple (N) instances of
Synchronization signal block (SSB) or
Primary synchronization signals (PSS)s or
Secondary synchronization signals (SSS)s or
Tracking reference signals (TRS)s, or
Channel state information reference signals (CSI-RS)s used for tracking or
a reference signal who structure is based on one or more of the above

N can be predefined or preconfigured by higher layers (e.g., via RRC). The RSs may be used by the UE for purposes such as achieving time/frequency synchronization or tracking, automatic gain control (AGC), or spatial information identification such a beam identification. The UE may use a wake-up receiver (WUR) for WUS detection and a main-receiver for performing WUS related action(s) in response to WUS detection. In such case the purposes described may be applicable for preparing the main receiver to perform the WUS related action(s).

The WUS related action(s) may include
PDCCH monitoring and/or detection of a downlink control information (DCI) format that schedules a paging message (e.g., if UE is in RRC IDLE mode)
PDCCH monitoring and/or detection of a paging early indication (PEI) message (e.g., DCI format with cyclic redundancy check (CRC) scrambled by a PEI radio network temporary identifier (RNTI)) (e.g., if UE is in RRC IDLE mode).
Starting of on-duration timer if the UE is performing procedures related to DRX operation (e.g., if UE is in RRC connected mode)
Performing a physical random access channel (PRACH) transmission (e.g., if the WUS includes a paging message for the UE) Performing PDCCH monitoring and/or detection
Reception of data, performing CSI measurements or reporting

Slot n0 may be the last slot in which WUS is detected if WUS spans multiple slots.

MTO may be configured as a number of slots or OFDM symbols or subframes or frames as defined in NR or in time units such as milliseconds.

MTO may be included as part of higher layer WUS configuration signaling.

This mechanism facilitates low power UE operation. For example, if MTO=X1 is configured (as shown in FIG. 5), the UE has a priori knowledge that—if the MR part of the UE is in a low power state (sleep state) during WUS monitoring, then at least duration X1 is available for it to transition from the sleep state to an active state (which consumes higher power than sleep state). Operating power for sleep states is typically lower if longer durations to transition from sleep to active are allowed. So, the UE can determine the lowest possible power consumption state for operating its MR based configuration of MTO.

For example, if MTO=X2<X1 is configured as shown in FIG. 5 (lower part), the MR may have to be prepared to wake up quickly but the UE may still operate in a sleep state with transition time smaller than X2. R0, R1, . . . shown in FIG. 5 represent one or more RSs. If MTO=X1 is configured, R2 is the first available RS(s) that the UE can use for preparing the MR, i.e., it is the first available after slot n2 determined based on slot n0 and MTO. If MTO=X2<X1 is configured, and earlier RS(s) R1 are available, the UE should use them for preparing the MR to perform the WUS related actions earlier compared to the case with MTO=X1.

MTO may be used with or without DRX operation configured for the UE (either in RRC_IDLE mode or in RRC_CONNECTED mode).

The MTO may be configured by a network node (e.g., gNB) based on acceptable latency associated with the WUS related action(s).

The UE may indicate one or multiple preferred time offset values to the gNB. The configured MTO may be based on the preferred time offset values (e.g., MTO configured to be larger than at least the minimum preferred value). The preferred time offset values may be indicated via UE capability signaling (e.g., via RRC) or via UE assistance signaling (e.g., via RRC or medium access control (MAC0 control element (CE) or physical layer indication).

Some embodiments include WUS triggered RS transmission after MTO.

In an embodiment, the UE is configured (e.g., via RRC) with a minimum time offset (MTO) associated with wake-up signal (WUS) reception. Upon detection of WUS, the UE determines a first slot (slot n1) with one or more reference signal(s) (RSs) where slot n1 is determined based on a slot in which WUS is detected (slot n0) and the MTO. The UE may determine a second slot (slot n2) such that the UE is ready to perform action(s) related to WUS detection in a set of slots that follow the second slot (or alternately in a set of slots starting with the second slot).

In response to WUS detection the UE performs the WUS related action(s) in a third slot (slot n3) from the set of slots. Slot n3 need not be same as slot n2 or a slot that immediately follows slot n2.

The RSs in slot n1 may be present only in slot n1 or may be present in multiple slots starting with slot n1.

Slot n2 may be a slot immediately following the slots with the RSs or may be a slot that is a few additional slots later than the slots with the RSs. Slot n2 may be the same as slot n1.

The RSs may have similar structure to one or more of the following NR signals:
TRS or CSI-RSs used for tracking or
An aperiodic CSI-RS for tracking for fast SCell activation
PSSs or
SSSs

The UE may determine structure of the RSS (e.g., bandwidth, time duration such a number of slots/repetitions) based on higher layer signaling (e.g., RRC) and/or based on information provided by the WUS. The UE may determine slot n1 based on information provided (e.g., an offset value) provided by the WUS.

The RSs may be used by the UE for purposes such as achieving time/frequency synchronization or tracking, AGC, or spatial information identification such a beam identification. The UE may use a WUR for WUS detection and a MR for performing WUS related action(s) in response to WUS detection. In such case the purposes described may be applicable for preparing the MR to perform the WUS related action(s).

The WUS related action(s) may be similar to those described above. MTO configuration details and details of slot n0 may be as described above.

These embodiments facilitate low power UE operation in similar manner as explained above with the additional advantage of lower latency. Here, WUS is coupled with an on-demand synchronization signal transmission so that UE MR can be ready as soon as possible without having to wait extra time for occurrence of periodic reference signals such as those within SSBs.

FIG. 7 illustrates another example of minimum time offset. The horizontal axis represents time domain. A UE detects WUS in slot n0 and determines slot n1 using slot n0 and the configured MTO. Slot n1 has reference signal RW. UE may use the RW instead of waiting for another periodic reference signal (R2 in case MTO=Y1 is used as in top part of FIG. 7 or R1 in case MTO=Y2<Y1 is used as in bottom part of FIG. 7) and be ready to perform WUS related actions with lower latency compared to the previous example.

Below is an example captured for how the MR power down time may be captured as part of 3GPP Release 19 in TS 38.331 (using v17.2.0 as baseline) section 6.3.3 using a new information element mr-powerDownTime-r19.

The IE PowSav-Parameters is used to convey the capabilities supported by the UE for the power saving preferences.

### PowSav-Parameters Information Element

-- ASN1START
-- TAG-POWSAV-PARAMETERS-START

| PowSav-Parameters-r16 ::= | SEQUENCE { | |
|---|---|---|
| powSav-ParametersCommon-r16 | PowSav-ParametersCommon-r16 | OPTIONAL, |
| powSav-ParametersFRX-Diff-r16 | PowSav-ParametersFRX-Diff-r16 | OPTIONAL, |

...
}

| PowSav-Parameters-v1700 ::= | SEQUENCE { | |
|---|---|---|
| powSav-ParametersFR2-2-r17 | PowSav-ParametersFR2-2-r17 | OPTIONAL, |

...
}

| | |
|---|---|
| PowSav-Parameters-v1900 ::= | SEQUENCE { |
| powSav-ParametersWUR-r19 | PowSav-ParametersWUR-r19 OPTIONAL, |

...
}

| PowSav-ParametersCommon-r16 ::= | SEQUENCE { | |
|---|---|---|
| drx-Preference-r16 | ENUMERATED {supported} | OPTIONAL, |
| maxCC-Preference-r16 | ENUMERATED {supported} | OPTIONAL, |
| releasePreference-r16 | ENUMERATED {supported} | OPTIONAL, |

-- R1 19-4a: UE assistance information

| | | |
|---|---|---|
| minSchedulingOffsetPreference-r16 | ENUMERATED {supported} | OPTIONAL, |

...
}

| PowSav-ParametersFRX-Diff-r16 ::= | SEQUENCE { | |
|---|---|---|
| maxBW-Preference-r16 | ENUMERATED {supported} | OPTIONAL, |
| maxMIMO-LayerPreference-r16 | ENUMERATED {supported} | OPTIONAL, |

...
}

| PowSav-ParametersFR2-2-r17 ::= | SEQUENCE { | |
|---|---|---|
| maxBW-Preference-r17 | ENUMERATED {supported} | OPTIONAL, |
| maxMIMO-LayerPreference-r17 | ENUMERATED {supported} | OPTIONAL, |

...
}

| | |
|---|---|
| PowSav-Parameters-v1900::= | SEQUENCE { |
| mr-powerDownTime-r19 | ENUMERATED {ms1, ms2, ms4, ms8, ms16, ms32, ms64, ms128}, |
| | OPTIONAL, |

...
}
-- TAG-POWSAV-PARAMETERS-STOP
-- ASN1STOP

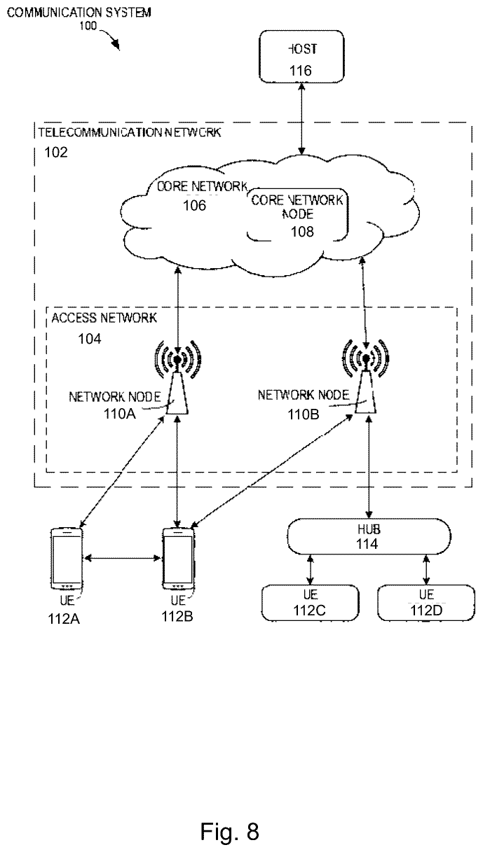

FIG. 8 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

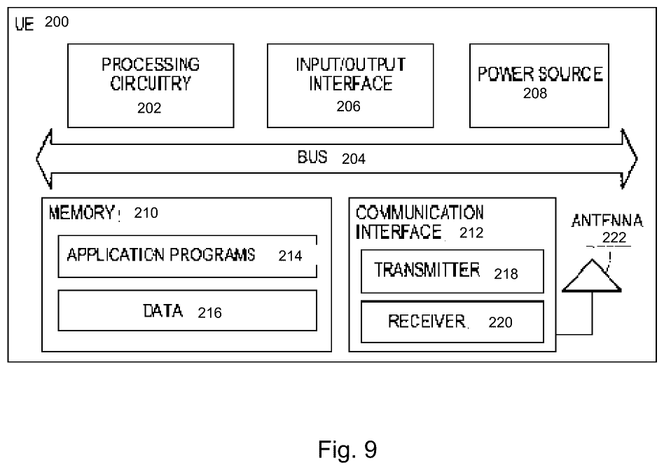

FIG. 9 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

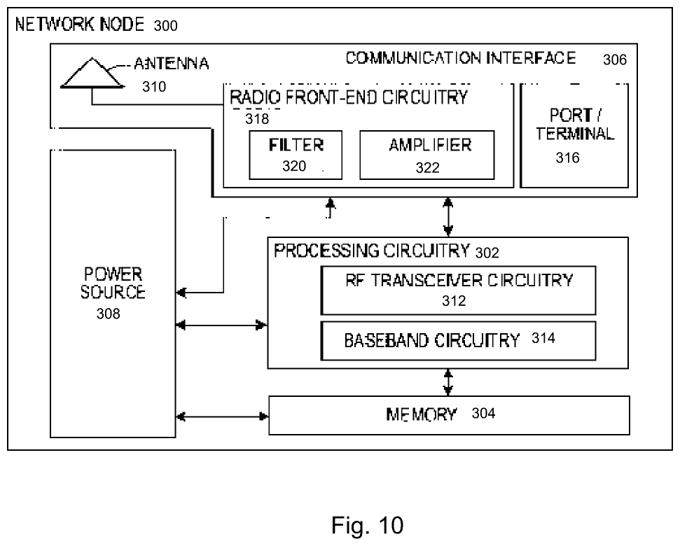

FIG. 10 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 10 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

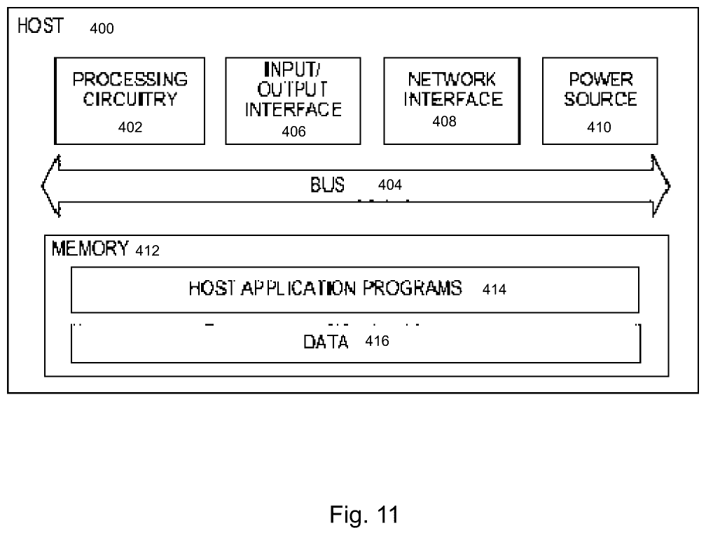

FIG. 11 is a block diagram of a host 400, which may be an embodiment of the host 116 of FIG. 8, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

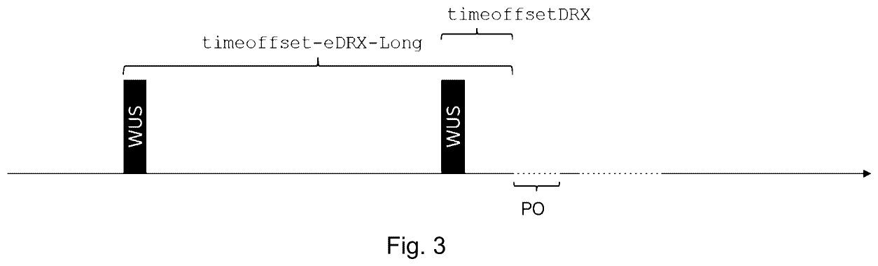

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

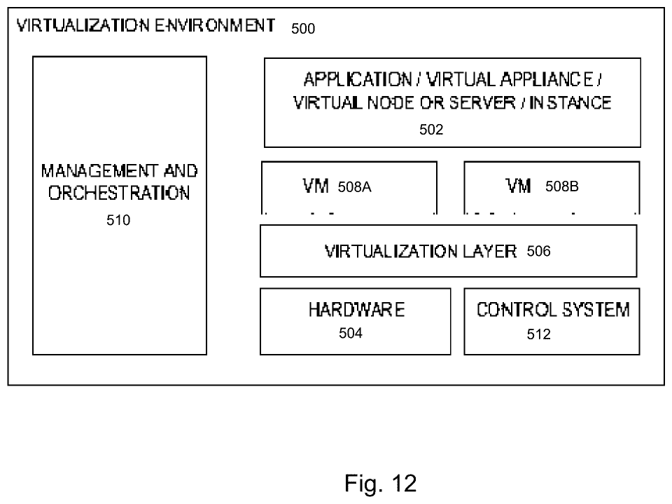

FIG. 12 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

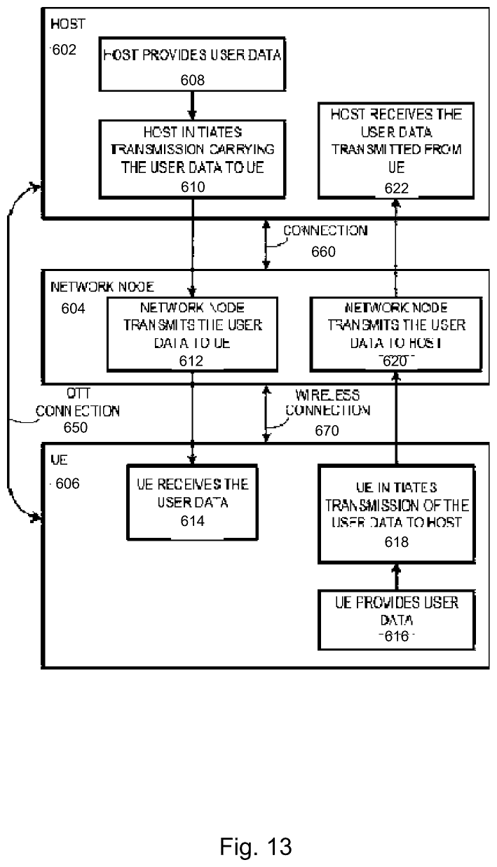

FIG. 13 shows a communication diagram of a host 602 communicating via a network node 604 with a UE 606 over a partially wireless connection in accordance with some embodiments. Example implementations, in accordance with various embodiments, of the UE (such as a UE 112a of FIG. 8 and/or UE 200 of FIG. 9), network node (such as network node 110a of FIG. 8 and/or network node 300 of FIG. 10), and host (such as host 116 of FIG. 8 and/or host 400 of FIG. 11) discussed in the preceding paragraphs will now be described with reference to FIG. 13.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 8) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

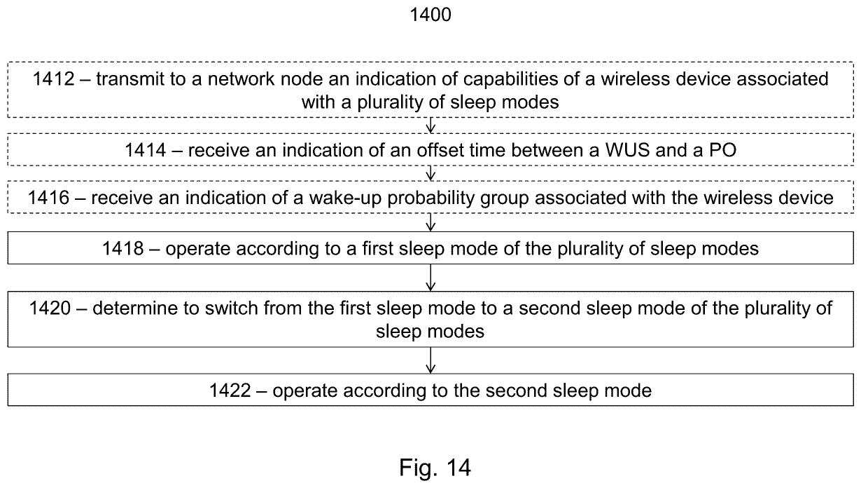

FIG. 14 is a flowchart illustrating an example method in a wireless device, according to certain embodiments. In particular embodiments, one or more steps of FIG. 14 may be performed by UE 200 described with respect to FIG. 9. The wireless device is capable of operating in a plurality of sleep modes.

The method may begin at step 1412, where the wireless device (e.g., UE 200) transmits to a network node an indication of capabilities of the wireless device associated with a plurality of sleep modes. For example, the wireless device may transmit capabilities regarding wake-up times or power down times associated with various receiver components, such as the main receiver (see, e.g., Table 1). Other examples are provided with respect to the embodiments and examples described herein.

At step 1414, the wireless device may receive an indication of an offset time between a WUS and a PO. For example, the wireless device may receive an indication of a minimum time offset, as described with respect to FIGS. 6 and 7.

At step 1416, the wireless device receives an indication of a wake-up probability group associated with the wireless device. For example, the wireless device may be configured by an AMF via NAS signaling which wake-up probability group the wireless device belongs to. The wake-up probability group may be used later when determining whether to switch sleep modes. Other examples are provided with respect to the embodiments and examples described herein.

At step 1418, the wireless device operates according to a first sleep mode of the plurality of sleep modes. For example, the wireless device may operate according to any of the sleep modes illustrated in FIG. 4.

At step 1420, the wireless device determines to switch from the first sleep mode to a second sleep mode of the plurality of sleep modes. In particular embodiments, determining to switch from the first sleep mode to the second sleep mode is based on a time offset between a WUS and a PO.

In particular embodiments, determining to switch from the first sleep mode to the second sleep mode is based on one or more of a: latency requirement; QoS; DRX or WUR duty-cycle length; RRC state; paging rate; traffic characteristics; WUR false alarm rate; coverage condition and deployment scenario; time-frequency synchronization requirements; RRM measurements; receiver architecture; clock parameters; and/or battery level.

In particular embodiments, determining to switch from the first sleep mode to the second sleep mode is based on a WUS detection rate for the wireless device or a wake-up probability for the wireless device. In particular embodiments, determining to switch from the first sleep mode to the second sleep mode is based on a timer associated with the first sleep mode. Other examples are provided with respect to the embodiments and examples described herein.

In particular embodiments, determining to switch from the first sleep mode to the second sleep mode comprises the wireless device autonomously determining to switch from the first sleep mode to the second sleep mode. For example, the wireless device may measure the wake-up probability over time and based on internal thresholds it determines the most favorable sleep state to reside in. Other examples are provided with respect to the embodiments and examples described herein.

In particular embodiments, determining to switch from the first sleep mode to the second sleep mode comprises receiving an indication from a network node to switch from the first sleep mode to the second sleep mode. For example, the network node may estimate the wireless device's wake-up probability based on history of data transmissions for the wireless device that triggered WUS, and WUS transmitted to other wireless devices in the wireless device's paging group. The network node may use thresholds internally to determine the most suitable power sleep state for the wireless device, which is then communicated to the wireless device. Other examples are provided with respect to the embodiments and examples described herein.

At step 1422, the wireless device operates according to the second sleep mode. For example, the wireless device may operate according to any of the sleep modes illustrated in FIG. 4.

Modifications, additions, or omissions may be made to method 1400 of FIG. 14. Additionally, one or more steps in the method of FIG. 14 may be performed in parallel or in any suitable order.

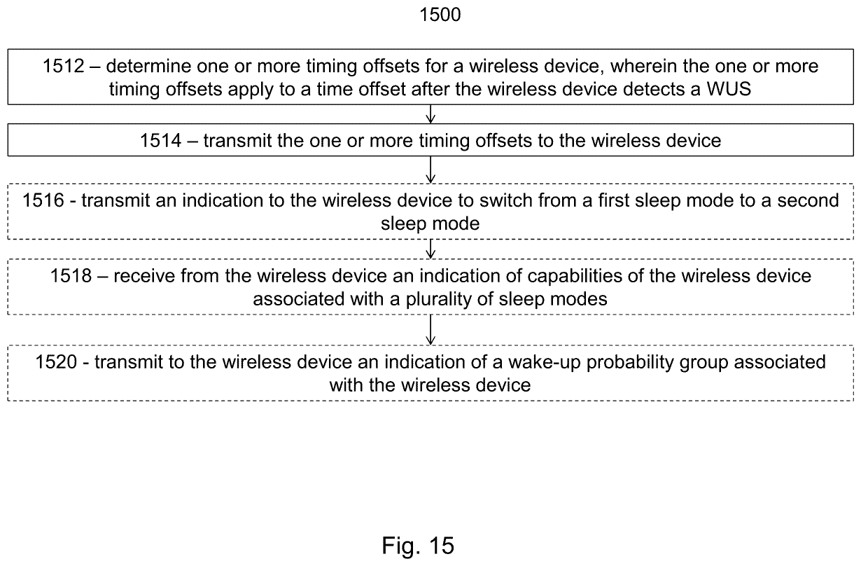

FIG. 15 is a flowchart illustrating an example method in a network node, according to certain embodiments. In particular embodiments, one or more steps of FIG. 15 may be performed by network node 300 described with respect to FIG. 10. The network node is in communication with a wireless device configured for performing wakeup signal monitoring. The wireless device is capable of operating in a plurality of sleep modes.

The method begins at step 1512, where the network node (e.g., network node 300) determines one or more timing offsets for the wireless device. The one or more timing offsets apply to a time offset after the wireless device detects a WUS.

In particular embodiments, determining one or more timing offsets is based on a sleep mode of the wireless device. Determining one or more timing offsets may be further based on one or more of a wakeup probability group and a DRX cycle associated with the wireless device.

In particular embodiments, a timing offset of the one or more timing offsets comprises an offset between the WUS and a PO.

At step 1514, the network node transmits the one or more timing offsets to the wireless device. Examples are provided with respect to the embodiments and examples described herein.

At step 1516, the network node may transmit an indication to the wireless device to switch from a first sleep mode to a second sleep mode. For example, the network node may estimate the wireless device's wake-up probability based on history of data transmissions for the wireless device that triggered WUS, and WUS transmitted to other wireless devices in the wireless device's paging group. The network node may use thresholds internally to determine the most suitable power sleep state for the wireless device, which is then communicated to the wireless device. Other examples are provided with respect to the embodiments and examples described herein.

At step 1518, the network node may receive from the wireless device an indication of capabilities of the wireless device associated with the plurality of sleep modes. For example, the network node may receive capabilities regarding wake-up times or power down times associated with various receiver components, such as the main receiver (see, e.g., Table 1). Other examples are provided with respect to the embodiments and examples described herein.

At step 1520, the network node may transmit to the wireless device an indication of a wake-up probability group associated with the wireless device. Examples are provided with respect to the embodiments and examples described herein.

Modifications, additions, or omissions may be made to method 1500 of FIG. 15. Additionally, one or more steps in the method of FIG. 15 may be performed in parallel or in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.

### Group A Embodiments

1. A method performed by a wireless device for performing wakeup signal monitoring, the wireless device capable of operating in a plurality of sleep modes, the method comprising:
   operating according to a first sleep mode of the plurality of sleep modes;
   determining to switch from the first sleep mode to a second sleep mode of the plurality of sleep modes; and
   operating according to the second sleep mode.
2. The method of the previous embodiment, wherein determining to switch from the first sleep mode to the second sleep mode is based on one or more of:
   a. offset between a wakeup signal (WUS) and a paging occasion (PO);
   b. latency requirements;
   c. quality of service (QoS);
   d. discontinuous reception (DRX) or wakeup radio (WUR) duty-cycle length;
   e. RRC state (Idle, Inactive, Connected);
   f. paging rate (Idle mode);
   g. traffic characteristics (Connected mode);
   h. WUR false alarm rate;
   i. coverage condition and deployment scenario;
   j. time-frequency synchronization requirements;
   k. RRM measurements;
   l. receiver architecture;
   m. clock parameters; and
   n. battery level.
3. The method of any one of the previous embodiments, wherein the wireless device autonomously determines to switch from the first sleep mode to the second sleep mode.
4. The method of any one of embodiments 1-2, wherein the wireless device receives an indication from a network node to switch from the first sleep mode to the second sleep mode.
5. A method performed by a wireless device, the method comprising:
   any of the wireless device steps, features, or functions described above, either alone or in combination with other steps, features, or functions described above.
6. The method of the previous embodiment, further comprising one or more additional wireless device steps, features or functions described above.
7. The method of any of the previous embodiments, further comprising:
   providing user data; and
   forwarding the user data to a host computer via the transmission to the base station.

### Group B Embodiments

8. A method performed by a base station in communication with a wireless device configured for performing wakeup signal monitoring, the wireless device capable of operating in a plurality of sleep modes, the method comprising:
   determining one or more timing offsets for a wireless device, wherein the one or more timing offsets apply to a time offset after the wireless device detects a wakeup signal (WUS); and
   transmitting the one or more timing offsets to the wireless device.
9. The method of the previous embodiment, wherein determining one or more timing offsets is based on a sleep mode of the wireless device.
10. The method of the previous embodiment, wherein determining one or more timing offsets is further based on one or more of a wakeup probability group and a discontinuous reception (DRX) cycle associated with the wireless device.
11. method of any one of the previous embodiments, wherein a timing offset of the one or more timing offsets comprises an offset between the WUS and a paging occasion (PO).
12. The method of any one of the previous embodiments, wherein a timing offset of the one or more timing offsets comprises
13. A method performed by a base station, the method comprising:
   any of the steps, features, or functions described above with respect to base station, either alone or in combination with other steps, features, or functions described above.
14. The method of the previous embodiment, further comprising one or more additional base station steps, features or functions described above.
15. The method of any of the previous embodiments, further comprising:
   obtaining user data; and
   forwarding the user data to a host computer or a wireless device.

### Group C Embodiments

16. A mobile terminal comprising:
   processing circuitry configured to perform any of the steps of any of the Group A embodiments; and
   power supply circuitry configured to supply power to the wireless device.
17. A base station comprising:
   processing circuitry configured to perform any of the steps of any of the Group B embodiments;
   power supply circuitry configured to supply power to the wireless device.
18. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
19. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
20. The communication system of the pervious embodiment further including the base station.
21. The communication system of the previous 2 embodiments, further including the UE, wherein the UE is configured to communicate with the base station.
22. The communication system of the previous 3 embodiments, wherein:
   the processing circuitry of the host computer is configured to execute a host application, thereby providing the user data; and
   the UE comprises processing circuitry configured to execute a client application associated with the host application.
23. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
24. The method of the previous embodiment, further comprising, at the base station, transmitting the user data.
25. The method of the previous 2 embodiments, wherein the user data is provided at the host computer by executing a host application, the method further comprising, at the UE, executing a client application associated with the host application.
26. A user equipment (UE) configured to communicate with a base station, the UE comprising a radio interface and processing circuitry configured to performs any of the previous 3 embodiments.
27. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
28. The communication system of the previous embodiment, wherein the cellular network further includes a base station configured to communicate with the UE.
29. The communication system of the previous 2 embodiments, wherein:
   the processing circuitry of the host computer is configured to execute a host application, thereby providing the user data; and
   the UE's processing circuitry is configured to execute a client application associated with the host application.
30. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
31. The method of the previous embodiment, further comprising at the UE, receiving the user data from the base station.
32. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
33. The communication system of the previous embodiment, further including the UE.
34. The communication system of the previous 2 embodiments, further including the base station, wherein the base station comprises a radio interface configured to communicate with the UE and a communication interface configured to forward to the host computer the user data carried by a transmission from the UE to the base station.
35. The communication system of the previous 3 embodiments, wherein:
   the processing circuitry of the host computer is configured to execute a host application; and
   the UE's processing circuitry is configured to execute a client application associated with the host application, thereby providing the user data.
36. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
37. A method implemented in a communication system including a host computer, a base station and a user equipment (UE), the method comprising:
   at the host computer, receiving user data transmitted to the base station from the UE, wherein the UE performs any of the steps of any of the Group A embodiments.
38. The method of the previous embodiment, further comprising, at the UE, providing the user data to the base station.
39. The method of the previous 2 embodiments, further comprising:
   at the UE, executing a client application, thereby providing the user data to be transmitted; and
   at the host computer, executing a host application associated with the client application.
40. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
41. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
42. The communication system of the previous embodiment further including the base station.
43. The communication system of the previous 2 embodiments, further including the UE, wherein the UE is configured to communicate with the base station.
44. The communication system of the previous 3 embodiments, wherein:
   the processing circuitry of the host computer is configured to execute a host application;
   the UE is configured to execute a client application associated with the host application, thereby providing the user data to be received by the host computer.
45. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
46. The method of the previous embodiment, further comprising at the base station, receiving the user data from the UE.
47. The method of the previous 2 embodiments, further comprising at the base station, initiating a transmission of the received user data to the host computer.

1. A method performed by a wireless device for performing wake-up signal, WUS, monitoring, the wireless device capable of operating in a plurality of sleep modes, the method comprising:
operating according to a first sleep mode of the plurality of sleep modes;
determining to switch from the first sleep mode to a second sleep mode of the plurality of sleep modes; and
operating according to the second sleep mode.

2.-11. (canceled)

12. A wireless device capable of performing wake-up signal, WUS, monitoring, and operating in a plurality of sleep modes, the wireless device comprising processing circuitry operable to:
operate according to a first sleep mode of the plurality of sleep modes;
determine to switch from the first sleep mode to a second sleep mode of the plurality of sleep modes; and
operate according to the second sleep mode.

13. The wireless device of claim 12, wherein the processing circuitry is operable to determine to switch from the first sleep mode to the second sleep mode based on a time offset between a WUS and a paging occasion, PO.

14. The wireless device of claim 12, wherein the processing circuitry is operable to determine to switch from the first sleep mode to the second sleep mode based on one or more of a:
latency requirement;
quality of service, QoS;
discontinuous reception, DRX, or wakeup radio, WUR, duty-cycle length;
Radio Resource Control, RRC, state;
paging rate;
traffic characteristics;
WUR false alarm rate;
coverage condition and deployment scenario;
time-frequency synchronization requirements;
Radio Resource Management, RRM, measurements;
receiver architecture;
clock parameters; and
battery level.

15. The wireless device of claim 12, wherein the processing circuitry is operable to determine to switch from the first sleep mode to the second sleep mode based on a WUS detection rate for the wireless device or a wake-up probability for the wireless device.

16. The wireless device of claim 12 wherein the processing circuitry is operable to determine to switch from the first sleep mode to the second sleep mode based on a timer associated with the first sleep mode.

17. The wireless device of claim 12, wherein the processing circuitry is operable to determine to switch from the first sleep mode to the second sleep mode by autonomously determining to switch from the first sleep mode to the second sleep mode.

18. The wireless device of claim 12, wherein the processing circuitry is operable to determine to switch from the first sleep mode to the second sleep mode by receiving an indication from a network node to switch from the first sleep mode to the second sleep mode.

19. The wireless device of claim 12, the processing circuitry further operable to transmit to a network node an indication of capabilities of the wireless device associated with the plurality of sleep modes.

20. The wireless device of claim 19, wherein the capabilities include one or more of a time to wake up a main receiver and time to power off the main receiver.

21. The wireless device of claim 12, the processing circuitry further operable to receive an indication of an offset time between a WUS and a paging occasion, PO.

22. The wireless device of claim 12, the processing circuitry further operable to receive an indication of a wake-up probability group associated with the wireless device.

23. A method performed by a network node in communication with a wireless device configured for performing wakeup signal monitoring, the wireless device capable of operating in a plurality of sleep modes, the method comprising:
determining one or more timing offsets for a wireless device, wherein the one or more timing offsets apply to a time offset after the wireless device detects a wakeup signal, WUS; and
transmitting the one or more timing offsets to the wireless device.

24.-30. (canceled)

31. A network node capable of communication with a wireless device configured for performing wakeup signal monitoring, the wireless device capable of operating in a plurality of sleep modes, the network node comprising processing circuitry operable to:
determine one or more timing offsets for a wireless device, wherein the one or more timing offsets apply to a time offset after the wireless device detects a wakeup signal, WUS; and
transmit the one or more timing offsets to the wireless device.

32. The network node of claim 31, wherein the processing circuitry is operable to determine one or more timing offsets based on a sleep mode of the wireless device.

33. The network node of claim 31, wherein the processing circuitry is operable to determine one or more timing offsets further based on one or more of a wakeup probability group and a discontinuous reception, DRX, cycle associated with the wireless device.

34. The network node of claim 31, wherein a timing offset of the one or more timing offsets comprises an offset between the WUS and a paging occasion, PO.

35. The network node of claim 31, the processing circuitry further operable to transmit an indication to the wireless device to switch from a first sleep mode to a second sleep mode.

36. The network node of claim 31, the processing circuitry further operable to receive from the wireless device an indication of capabilities of the wireless device associated with the plurality of sleep modes.

37. The network node of claim 36, wherein the capabilities include one or more of a time to wake up a main receiver and time to power off the main receiver.

38. The network node of claim 31, the processing circuitry further operable to transmit to the wireless device an indication of a wake-up probability group associated with the wireless device.
